(19) United States
(12) Patent Application Publication
(10) Pub. No.: US 2022/0382663 A1
(43) Pub. Date: Dec. 1, 2022

(54) PREDICTING EVENT LOG ENTRIES

(71) Applicant: Hewlett-Packard Development Company, L.P., Spring, TX (US)

(72) Inventors: Daniel Cameron Ellam, Bristol (GB); Arjun Perumalla, Bristol (GB); Adrian John Baldwin, Bristol (GB)

(21) Appl. No.: 17/755,891

(22) PCT Filed: Dec. 20, 2019
(86) PCT No.: PCT/US2019/067797

§ 371 Date: May 11, 2022

(51) Int. Cl. G06F 11/34; G06F 11/30

(52) U.S. Cl. CPC G06F 11/3476; G06F 11/3055; G06F 2201/86; G06F 2201/835

(57) ABSTRACT

A method is disclosed. The method comprises analyzing, using a processing apparatus, event log entries of a plurality of devices, the plurality of devices forming part of a group of devices sharing a common attribute, wherein event log entries of a device relate to events that have taken place during a first period of interest in respect of that device. The method also comprises determining, using the processing apparatus, for a given device in the group of devices, based on the analysis of event log entries, a predicted entry that is expected to appear in the event log of the given device during the first period of interest. An apparatus and a machine-readable medium are also disclosed.

### BACKGROUND

Data collected from a device or from multiple devices may be analyzed to assess the quality and/or characteristics of the data.

A device that performs tasks or functions may generate an event log, or produce data that can be used to generate an event log. Such an event log may include details of tasks that have taken place in respect of the device over a period of time. Analysis of data included in an event log for a device may be used to reveal information about the device.

### BRIEF DESCRIPTION OF DRAWINGS

Examples will now be described, by way of non-limiting example, with reference to the accompanying drawings, in which:

FIG. 1 is a schematic of an example of devices connected to a management module;

FIG. 2 is an illustration of an example of timelines showing event logging in respect of various devices;

FIG. 3 is a flowchart of an example of a method of determining a predicted event log entry for a device;

FIG. 4 is a flowchart of a further example of a method of determining a predicted event log entry for a device;

FIG. 5 is a flowchart of a further example of a method of determining a predicted event log entry for a device;

FIG. 6 is a schematic illustration of an example of an apparatus for estimating event information for a device; and

FIG. 7 is a schematic illustration of a processor in communication with a machine-readable medium.

### DETAILED DESCRIPTION

This disclosure relates to devices which are capable of performing functions. For example, the devices may comprise printing devices, scanning devices, photocopy devices, display devices, detection devices, monitoring devices, and the like. It will be understood that the term “device”, also referred to herein as “connected devices” may also include devices other than those mentioned above.

Events that are performed by or in respect of a device may be logged or recorded as data in an event log. Data describing an event may be recorded numerically, in the form of a numerical value, textually or non-numerically, in the form of text describing a particular event that has taken place, or alphanumerically, in the form of a combination of textual data and numerical data. While any event may be recorded as an entry in an event log for a device, examples of events include: the device being powered on, the device being powered off, a configuration setting of the device being changed, a security setting of the device being changed, a password or authentication credential of the device being changed, an instruction to perform a task (e.g. a printing task) being received by the device, an update of software/firmware of the device being instructed or performed, and so on. In some cases, any event involving an exchange (receipt and/or transmission) of data involving the device may be recorded in an event log. An event log records data defining or describing the event or events that have taken place, and an indication of the time at which each event took place.

Data may be recorded in an event log in one of a plurality of recording or logging levels, wherein each logging level corresponds to an amount of detail included in each entry. For example, events occurring in respect of a device may be recorded according to a plurality of levels L₁, L₂, . . . L_{N}, where events recorded according to logging level L₁ include the smallest amount of information or detail, and events recorded according to logging level L_{N} include the largest amount of information or detail. In a simple example, events may be recorded according to a first, ‘basic’ logging level, in which events may be described at a high-level, using a small number of words or terms, or to a second, more detailed or ‘enhanced’ logging level, in which events may be described at a lower, more detailed level, using a larger number of words or terms, such that more detail of the event can be recorded. In other examples, different levels of logging may include different types of events. For example, one logging level may involve recording events that are not recorded in another logging level. An example of an event log entry recorded according to a ‘basic’ level and an ‘enhanced’ level is shown in Table 1 below.

TABLE 1

| Logging Level | Entry |
|---|---|
| Basic | <device type>: Security: Security |
| | settings reset interface = <interface> |
| Enhanced | <device type>: Jetdirect security |
| | settings reset to factory defaults; |
| | time = “<timestamp>” outcome = success |
| | interface = <interface> |

According to examples disclosed herein, data in event logs of multiple devices may be analyzed and used to determine anomalies or potential security breaches. For example, if a number of devices in a particular setting are expected to behave in a manner (e.g. with similar configuration settings being distributed to all devices, and with similar management tasks being performed in respect of all devices), then a determination can quickly be made if the expected or intended event has not been performed in respect of one of the devices. Such a discrepancy may, for example, be evident by comparing the event logs of the devices. In some examples, the discrepancy may be the result of a technical fault having occurred with respect to a particular device, such as a power outage, network connectivity issues, a lossy network, a computer bug/virus resulting in a reduction of logging or some other fault resulting in events not being logged in the same way as events of other, similar devices. In some scenarios, logging for a device may, for a period of time, stop altogether, or the logging level of a device may be reduced unintentionally. Such a change, reduction or loss in event logging for the device may be indicative of a security breach, for example if logging has been maliciously disabled to disguise or hide a security attack. Moreover, a gap in an event log where no events have been logged for a particular device means that analysis of the events for that device may be flawed.

Periods of reduced or no logging may be rectified by predicting or estimating events that may have been expected to take place during the outage period. In some cases, an event log for a device with a period of reduced or missing event logging may be corrected or supplemented with such estimated events. Previous methods of correcting or adding an entry in an event log for a particular device (e.g. for a number of configuration changes occurring per hour) have involved calculating an average of that value for that particular device over the course of a day, for example, and adding the calculated value to the event log. This approach does not, however, take into account expected changes that might occur during particular periods of the day.

According to the present disclosure, devices are grouped according to a particular shared attribute or attributes, and devices within the same group are used to predict an event log entry or check event log entries for other another device in the group. That way, devices that might be considered to operate in a similar way, and that might be managed in the same way by having the same management operations applied to them (e.g. having the same configuration settings to all of the devices) are taken into account when predicting what event one might have expected to see in an event log. Unintended discrepancies might also be detected by comparing a predicted entry with an actual entry in an event log of a device. A discrepancy might indicate an unauthorized or unintended modification of the event log, as discussed below.

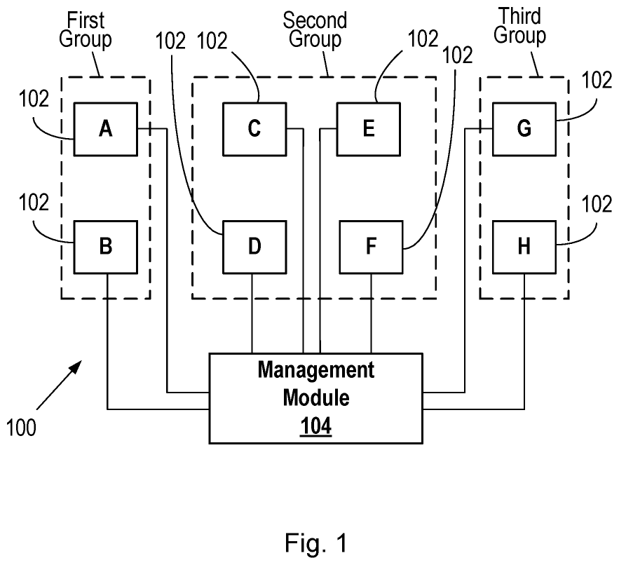

Referring to the drawings, FIG. 1 is a schematic illustration of an example of an arrangement 100 in which devices 102 are connected to a management module 104. In this example, eight devices are shown, labelled A to H. However, in other examples, the arrangement 100 may include more or fewer devices 102. Each device 102 is connected (e.g. via a wired or wireless connection) to the management module 104. The management module 104 may comprise a stand-alone computing device, or a module implemented using executable computer program code stored on a computing device or server. The management module 104 is capable of communicating with one or more of the devices 102, and may be used to send data, such as instruction data, to the devices to perform device management tasks. For example, when it is intended that a configuration setting of a device is to be changed or updated, the management module 104 may send instructions to the relevant device or devices to effect the intended change to the configuration settings. Such changes include, for example, changing a time and/or date of a device 102, updating the firmware/software installed on a device, and updating security settings (e.g. changing a password) of a device. The management module 104 may also be configured to send instructions to a device or devices relating to other administrative functions that are to be performed in respect of the device or devices.

Every event that takes place in respect of a device 102 may be recorded in an event log associated with that device. The event log may record events tasks performed by the device (e.g. details of a print job performed by a printing device) in addition to other events taking place in respect of the device (e.g. changes to configuration settings and so on). The event log of a device may be stored in the device itself, or in a storage medium associated with the device, such as at the management module 104. In some examples, the device itself may update its corresponding event log with events that have taken place while, in other examples, a device's event log may be updated by another component, such as the management module 104.

In some examples, the devices 102 may be devices located in an enterprise setting (e.g. in an office building, a medical facility such as a hospital, a school or university, or the like). The devices 102 may be referred to as connected devices or managed devices. In other words, the devices may receive control data or management data/instructions from a central controller or management system, such as the management module 104. In one example, a device of the devices 102 may comprise a print apparatus, or printer, and the printers may be distributed throughout an office building. For example, the printers A and B may be located on a first floor of the office building, printers C, D, E and F may be located on a second floor of the office building, and printers G and H may be located on third floor of the office building. Each of the printers 102 may be connected to the management module 104 via a network (e.g. a wireless local area network, WLAN).

As noted above, event logs for devices that share a common attribute or attributes may be expected to be similar. In other words, it may be expected that devices that share a similar attribute have similar events occurring in respect of them. While device-specific events, such as printing jobs being performed, will differ from device to device, many administrative tasks (e.g. those performed by the management module 104) may be performed to, or in respect of, all devices that share the common attribute. Devices that share a common attribute may be grouped together and considered as a group, since it may be intended or expected that their event logs will be similar. In the example discussed above with reference to FIG. 1, a common attribute may be that printers are located on the same floor of the office building. Thus, printers A and B may be considered to form a first group, printers C, D, E and F may be considered to form a second group, and printers G and H may be considered to form a third group. The location of the device is just one of a large number of attributes that may be taken into account when considering how to group devices. Thus other attributes in addition to the device location may be used to group the devices. In other examples, devices may be grouped according to a network address or an Internet protocol (IP) address, as it may be intended that devices on the same network or the same part of a network may treated similarly and may have similar events appearing on their event logs. Another attribute that may be used to group devices may be the software and/or firmware installed on the devices. For example, devices that have been installed with the same operating system may be expected to behave similarly, and may be managed in a substantially uniform manner. Examples of other attributes that may be used or taken into account when grouping devices include the type of device (e.g. printer, scanner, photocopier, and so on), the nature of the business in which the devices are to be used, and the department of the business for company in which the devices are to be used, the building in which the devices are installed, the version (e.g. determined by a model number or a serial number) of the devices. In another example, devices may be grouped according to who uses the devices, or according to device management patterns. Other attributes that may be used to group devices include the organizational unit, team or department of a business using the devices, the device management authority, and the time zone in which the device is located. In other examples, devices may be grouped in other ways, according to other attributes. In some examples, a device may belong to multiple groups, wherein devices belonging to the same group share a common attribute.

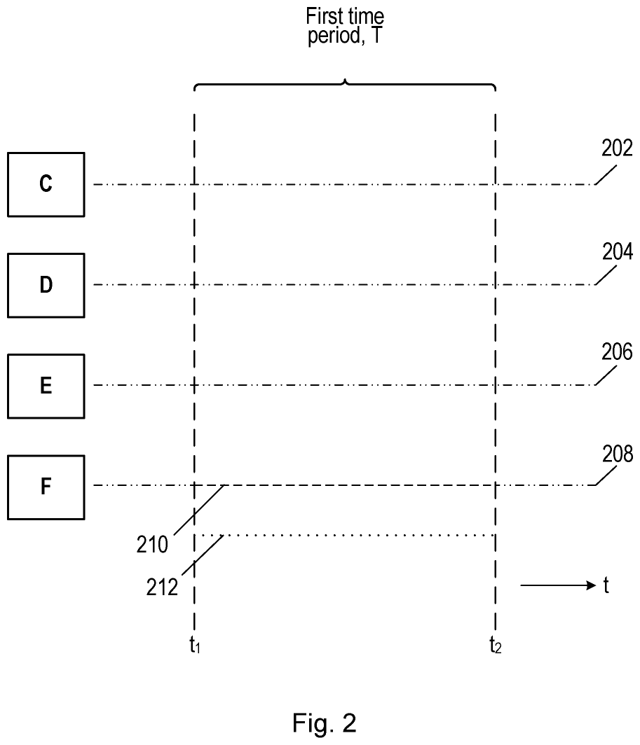

FIG. 2 is a schematic illustration of an example of device timelines for four devices. In this example, a first timeline 202 corresponds to the device C, a second timeline 204 corresponds to the device D, a third timeline 206 corresponds to the device C and a fourth timeline 208 corresponds to the device D. The dots and dashes shown in each timeline represent events that have occurred in respect of a corresponding device. Specifically, in this example, the dots and dashes represent a detailed, or enhanced, level of logging. The timelines 202, 204, 2064 the devices C, D and E respectively show that events are logged or recorded at the enhanced level over the entire period shown in FIG. 2. However, at a first time t₁, a change in the level of logging occurs in respect of the device F. Thus, at the time t₁, the timeline 208 changes from a sequence of dots and dashes to a series 210 of dashes (and no dots), indicating that recording of events has been changed to a basic level. A further example is also shown, in which the timeline 208 changes at the time t₁ from the sequence of dots and dashes to a series 212 of dots (and no dashes), indicating that recording of events has stopped completely. At a second time t₂, enhanced level recording of events is resumed for the device F, indicated by the sequence of dots and dashes in the timeline 208 after the second time t₂. Thus, in this example, the level of the event recording in respect of the device F changes (e.g. reduces) during a first time period, T, that occurs between the first time t₁ and the second time t₂. As noted previously, it may be intended that event logs of devices are complete and/or that all devices have event logs that have events recorded according to the same level of logging (e.g. an enhanced logging level). Thus, it may be intended that gaps in an event log of a device, or periods during which event logging was performed at a different (e.g. an intended) logging level (e.g. at a basic logging level rather than an enhanced logging level), may be corrected or supplemented with events that are predicted or estimated to have taken place.

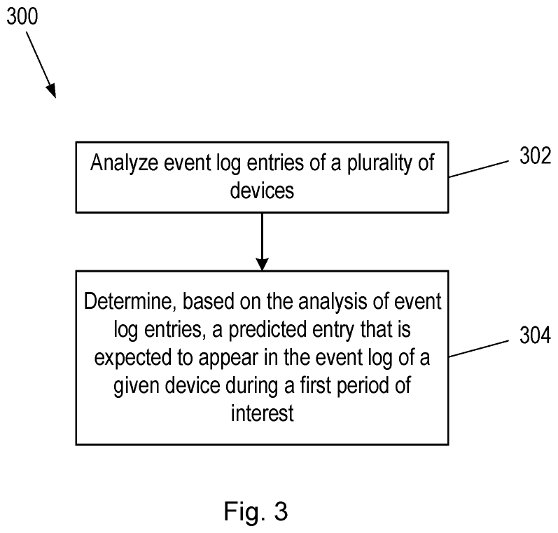

According to the above example, the devices C, D, E and F all form part of a group (i.e. the second group in the above example) as they share a common attribute (i.e. they are all located the same floor of an office building in this example). According to examples disclosed herein, a prediction of an event that is expected to have occurred in respect of a given device may be made based on an analysis of the events that took place in respect of other devices in the same group as the given device. In other words, devices that share a common attribute with the given device may be used to predict an event that is expected to have occurred in respect of the given device during a period of reduced event logging. In the example of FIG. 2, the event logs for the devices C, D and E may be analyzed and used to predict an event that is expected to have taken place in respect of the device F during the first time period, T. Examples of how event log entries may be predicted for a given device based on the event of entries of other similar devices (e.g. other devices in the same group, that share a common attribute) will be discussed with reference to the flow charts of FIGS. 3, 4, 5.

FIG. 3 is a flowchart of an example of a method 300. The method 300 may comprise a method of determining a predicted event log entry for a device, and may comprise a computer-implemented method. The method 300 comprises, at block 302, analyzing, using a processing apparatus, event log entries of a plurality of devices, the plurality of devices forming part of a group of devices sharing a common attribute, wherein event log entries of a device relate to events that have taken place during a first period of interest in respect of that device. The group of devices sharing a common attribute may, for example, comprise a group of devices (e.g. printers) that are located on the same floor of an office building, as in the example above. The group of devices may also (or alternatively) share other attributes, such as those discussed herein. The plurality of devices that form part of the group of devices comprise two or more devices and may, in some examples, comprise all of the devices in the group of devices. The event log entries for the plurality of devices comprise data describing the events that have taken place in respect of the devices. The entries for a device may be contained within an event log for that device. The event log entries may be continuous, such that a new event is added when it takes place, for the lifetime of the device (or as long as the event log is to continue). The analysis performed is in respect of evet log entries that have taken place (e.g. that appear in the event logs) during a defined period of time, referred to herein as the first period of interest.

The first period of interest may comprise a period during which it is intended to supplement missing or a reduced amount of event data for a device if, for example, a logging level has been reduced (e.g. from enhanced to basic event logging) or if logging has stopped altogether for a period of time. For example, the first period of interest may be the time period, T, shown in FIG. 2. While, in some examples (such as the example shown in FIG. 2), the first period of interest may comprise a period of time ranging from a time (e.g. t₁) when a period of reduced event logging begins to a time (e.g. t₂) when the period of reduced event logging ends, the first period of interest may, in other examples, comprise an arbitrary period of time, such as two hours, one hour, 30 minutes, 10 minutes, or the like. In examples where the first period of interest begins when a logging level reduces or stops, the start of the first period of interest may be triggered or identified by the generation or issuance of a signal or indication that a change in the logging level has occurred. For example, the device itself, or a processing apparatus (e.g. the management module 104) in communication with the device may recognize that the logging level has changed, or that logging has been stopped altogether, and note the time at which the change occurred, so that that time can be used as the start of the first period of interest. In other examples, periods of reduced event logging or periods where no events have been logged for a particular device may be identified retrospectively, by analyzing event logs that have already been generated. For example, event logs for devices within the same group may be analyzed, and any change in the event logging for a device that stands out from the logging of other devices may be determined to be an unintended change in event logging level.

The method 300 comprises, at block 304, determining, using a processing apparatus, for a given device in the group of devices, based on the analysis of event log entries, a predicted entry that is expected to appear in the event log of the given device during the first period of interest. Thus, block 304 involves predicting or estimating an event log entry that would have been expected to appear in the event log of one particular device in the group of devices sharing a common attribute during the first period of interest. The prediction of estimation is made using the analysis performed at block 302. In some examples, where the plurality of devices comprises just two devices, the analysis of block 302 may be in respect of the given device and just one other device. In such an example, the predicted entry that is expected to appear in the event log of the given device during the first period of interest may be determined based on the analysis of event log entries of just one other device (for example, even though event log entries may also be analyzed for the given device, they may be ignored or disregarded as part of the analysis).

Determining a predicted entry (at block 304) may be done in a number of ways. In the most basic scenario, event log entries of just one other device in the same group as the given device are analyzed (at 302), and those entries appearing in the event log of the other device during the first period of interest may be replicated and added into the event log of the given device during the first period of interest. The device that is selected whose event log is replicated may be determined using the methods described below, such that the selected device is that which is considered to be most similar to the given device. In other examples, event log entries of multiple other devices in the same group as the given device may be available and analyzed. In those examples, a measure of similarity between the given device and at least one other device of the plurality of devices may be calculated. Based on the calculated measure of similarity, those devices of the plurality of devices that are most similar (in terms of event log entries) to the given device may be used to determine a predicted entry for the given device.

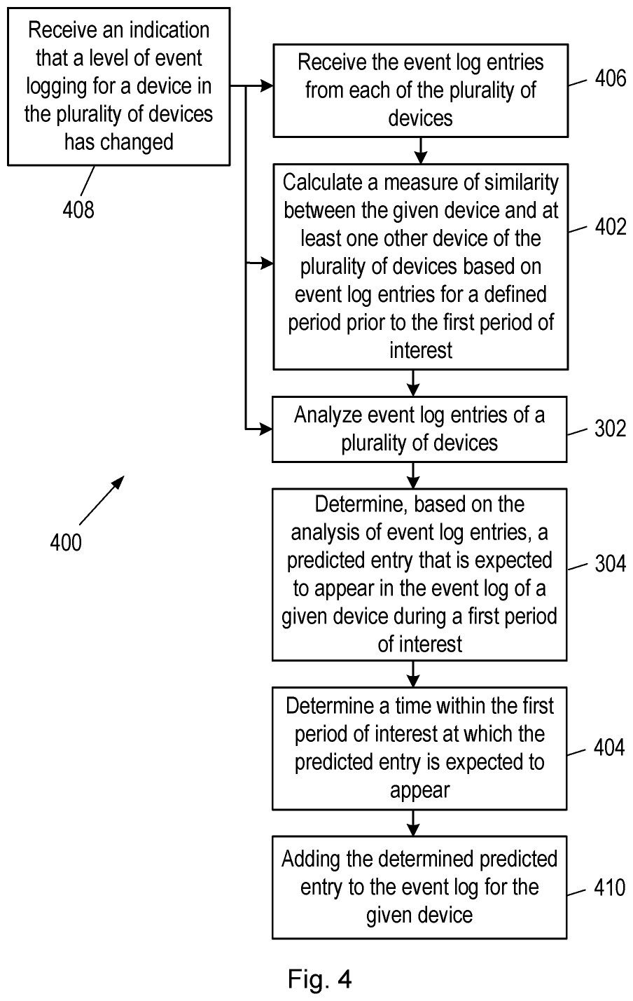

FIG. 4 is a flowchart of a further example of a method 400. The method 400 may comprise a method of determining a predicted event log entry for a device and, as with the method 300, may comprise a computer-implemented method. The method 400 may comprise blocks of the method 300 discussed above. At block 402, the method 400 may comprise, prior to said analyzing (at block 302), calculating a measure of similarity between the given device and at least one other device of the plurality of devices, based on event log entries for a defined period prior to the first period of interest. In this example, a measure of similarity between the given device and other devices in the plurality of devices is determined based on events appearing in the event logs prior to the period of reduced logging (e.g. during a period when events were logged for the given device and the other devices). In this way, it is possible to determine which of the plurality of devices is, or are, the most similar to the device in terms of the events that have taken place and are appearing in the event logs. In some examples, events appearing in an event log of one of the devices of a device of the plurality of devices may be identical to those appearing in the event log of the given device for a particular period. In other examples, however, event logs may be similar, with minor differences. In these examples, a device of the plurality of devices may be considered to be similar to the given device (in terms of event log entries) if the event log entries are similar to within a defined similarity threshold. For example, a numerical value appearing in the event log of a device may be considered similar to a corresponding value appearing in the event log of the given device if it is within a defined range. In another example, a time at which an event occurred in the event log for a device may be considered similar to the time of a corresponding event in the event log of the given device if the events occurred within a defined duration (e.g. within one minute) of one another. In general, in examples where a measure of similarity has been calculated (at block 402), then the analyzing of block 302 may comprise analyzing the event log entries for any device for which the calculated measure of similarity meets or exceeds a defined threshold similarity level. In some examples, the defined threshold similarity level may be met if a defined number or percentage of the events occur in respect of two devices within a given timeframe.

In some examples, a measure of similarity may be calculated by computing a similarity metric in respect of the plurality of devices. Such a similarity metric may be used to determine which events occurred in respect of each device in the plurality of devices during a particular period of time, and this can be used to predict an event, or events, likely to have occurred in respect of the given device. For example, consider a feature vector X=[x₁ x₂ . . . xⱼ], where xⱼ represents a unique event j that has occurred in respect of the given device. In this example, the feature vector x describes a frequency of each event occurring in respect of each device in the plurality of devices. A feature vector for the devices shown in FIG. 2 is shown in Table 2 below.

TABLE 2

| | x₁ | x₂ | x₃ |
|---|---|---|---|
| C | 1 | 2 | 1 |
| D | 2 | 3 | 1 |
| E | 2 | 2 | 1 |
| F | ? | ? | ? |

Table 2 shows the number of times each event x₁, x₂, x₃ has occurred in respect of each device C, D, E and F during the first period of interest. Since the device F experienced a reduction in its logging level during the first period of interest, the number of events occurring in respect of that device cannot be determined and, therefore, question marks are provided for that device. For a more general case, the feature vector may be created as shown in Table 3 below.

TABLE 3

| | x₁ | x₂ | xⱼ |
|---|---|---|---|
| d₁ | f_{(1, 1)} | f_{(1, 2)} | f_{(1, j)} |
| d₂ | f_{(2, 1)} | f_{(2, 2)} | f_{(2, j)} |
| dᵢ | f_{(i, 1)} | f_{(i, 2)} | f_{(i, j)} |
| d_{given} | ? | ? | ? |

In Table 3, f_{(i,j)} represents the number of times each event xⱼ has occurred in respect of device dᵢ during the first period of interest. The device d_{given} represents the given device whose event log entries for the first period of interest have not or cannot be determined.

A similarity metric may also be computed in respect of the defined period prior to the first period of interest. For example, a similarity metric may be computed in respect of the plurality of devices for a period of one hour leading up to the time at which the logging level for a given device was reduced. Using such a similarity metric, the events occurring in respect of the given device may be compared to the events occurring in respect of each other device. For each pair of devices (dᵢ, d_{given})statistical analysis may most similar to the given device. In some examples, a chi-squared analysis may be performed in respect of each pair of devices (dᵢ, d_{given}) Using the statistical analysis, the k devices that are most similar (e.g. within a defined similarity threshold) to the given device d_{given} may be determined. In some examples, an average (e.g. mean) number of each of the events may be calculated across the k similar devices, and this may be used to determine a number of each of those events to be included in the event of for the given device.

In some cases it may be sufficient to determine just which events are expected to have occurred in respect of the given device during the first period of interest. A more accurate event log for the given device may be predicted by estimating the number of occurrences of each event during the first period of interest. However, and even more accurate event log for the given device may be predicted by estimating the time within the first period of interest at which each event is expected to have occurred. Thus, the method 400 may comprise, at block 404, determining, using a processing apparatus, a time within the first period of interest at which the predicted entry is expected to appear. One example approach for determining the times of occurrence of each of the predicted events is described below.

In some examples, determining the time at which the predicted entry is expected to appear may comprise discretizing the first period of interest into a plurality of intervals. Thus, with reference to the example shown in FIG. 2, the first time period, T, may be discretized into a plurality of intervals [t₁, t₂ . . . tₘ]. The time at which the predicted entry is expected to appear may then be determined based on a number of event log entries appearing in the event logs of the plurality of devices during each of the plurality of intervals. Put another way, the event log entries of the plurality of devices may be analyzed to determine how many occurrences of each event occurred during each time interval tₘ. In some examples, a number of occurrences of a particular event may be added into the time interval tₘ of the event log for the given device based on an average (e.g. mean) number of occurrences of that event in the k similar devices during the same time interval. In one example, the mean and standard deviation of the number of occurrences of an event in the k similar devices may be taken into account when determining the time at which the event is expected to have occurred in respect of the given device. For example, it may, in some examples, be assumed that X˜N(μ, σ²), where X represents the number of times event (eⱼ) occurs across k similar devices. This assumption is based on observed data. A confidence threshold (e.g. 90% or 95%), which can be derived using the model given above (e.g. N(μ, σ²)) may be used to determine whether or not a particular event is expected to have occurred within a particular time interval in respect of the given device, and the number of times that event is expected to have occurred.

As noted briefly above, the event logs and the event log entries maybe created and/or stored by the devices themselves or at a central location, such as a storage medium associated with a server, or associated with the management module 104. Prior to performing the blocks of the methods 300, 400 disclosed herein, the method may further comprise, at block 406, receiving the event log entries from each of the plurality of devices.

The methods disclosed herein are used for a number of purposes, and two example scenarios are described below.

In a first scenario, a predicted event log entry that is determined (e.g. at block 304) may be used to supplement an event log of a given device when a logging level for the given device has been reduced, or when event logging for the given device has been stopped altogether. As discussed above, in some examples, event log entries for a device may be recorded according to one of a plurality of levels of event logging. The method 400 may further comprise, at block 408, prior to said analyzing of block 302, receiving an indication that a level of event logging for a device in the plurality of devices has changed. Block 408 may occur at any time prior to block 302, including prior to block 402 and/or prior to block 406, as indicated in FIG. 4. The indication that the logging level has changed may be generated by the device whose logging level has changed. In some examples, an event may be recorded in a device's event log that indicates that a change in logging level has occurred, such as a “logging stopped” event and a “logging started” event. Similarly, a “basic logging level started” event and an “enhanced logging level started” event may be recorded, indicating a period of reduced event logging. The analyzing (of block 302) may be performed responsive to receiving the indication.

The method 400 may further comprise, at block 410, adding, using a processing apparatus, the determined predicted entry to the event log for the given device. Thus, once a predicted entry has been determined at block 304, that event may be added to the event log, to fill in the event log for the first period of interest. In some examples, multiple event log entries may be predicted, and those multiple entries may be added to the event log for the given device.

In some examples, where the level of event logging has reduced during the period of interest, predicted entries for the given device may be determined based on a predefined mapping between entries of different levels. For example, if the logging level was reduced from “enhanced” to “basic” for the given device during the first period of interest, then a predetermined mapping between “enhanced” entries and “basic” entries may be used to determine the predicted entries. The predefined mapping may, for example, be stored in a database or lookup table in a storage medium accessible to an apparatus performing the method 300, 400.

In a second scenario, a predicted event log entry that is determined (e.g. at block 304) may be used to check the accuracy of a devices event log. In this example, the predicted entry may be used to detect a security breach, for example where an event log of a device has been modified (e.g. maliciously). This example relates to a scenario where a change in the level of event logging may not have been detected or indicated. Therefore, events may have occurred in respect of each of the plurality of devices, and entries may have been logged in event logs for each device. In this example, event log entries for the plurality of devices are analyzed, and a predicted entry for a given device (i.e. one of the plurality of devices) is compared to entries appearing in the event log in order to determine its accuracy. This may be done for multiple event log entries over a period of time (e.g. the first period of interest), and if the predicted entries are the same as, or similar to within a defined similarity threshold, the actual entries appearing in the event log for the given device, then it may be determined that the recorded event log entries are genuine and accurate. However, if the predicted event log entries for the given device differ from the actual event log entries recorded by more than a defined similarity threshold, then it may be determined that the event log entries appearing in the event log are inaccurate or have been modified, for example.

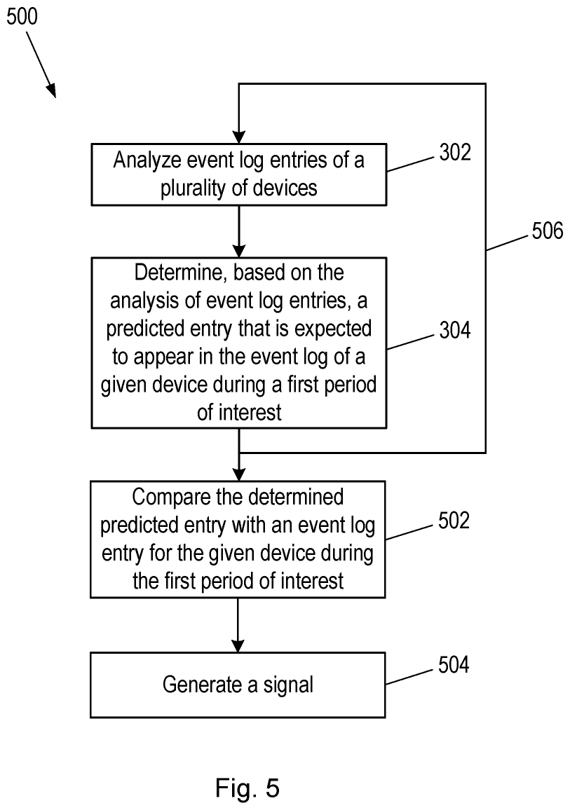

The second scenario is described with reference to FIG. 5, which is a flowchart of an example of a method 500. The method 500 may comprise a method of determining a predicted event log entry for a device and, as with the methods 300, 400, may comprise a computer-implemented method. The method 500 may comprise blocks of the methods 300, 400 discussed above. At block 502, the method 500 may comprise comparing, using a processing apparatus, the determined predicted entry with an event log entry for the given device during the first period of interest. At block 504, the method 500 may comprise, responsive to determining that the predicted entry differs from the event log entry by more than a defined threshold, generating an alert signal. Thus, in one example, if the predicted number of occurrences of a particular event within a defined time interval within the first period of interest differs from the actual number of occurrences of that particular event according to the event log by more than a defined threshold, then an alert signal may be generated. The defined threshold may be set according to the intended level of similarity between the predicted events and the actual events appearing in the event.

In this example, the blocks of the method 500 may be repeated for all of the devices in the plurality of devices, such that each device is, in turn, considered to be the given device. In other words, the event logs of each device may be checked in order to determine whether or not the events appearing in the actual event log for that device correspond with (e.g. are the same as or similar to) the predicted event(s) for that device. In this way, it is possible to detect a possible security breach or malicious modification of an event log for any device in the plurality of devices.

The alert signal that is generated at block 504 may comprise any alert signal suitable for informing a computing device or operator of a potential discrepancy between the predicted entries and the actual entries of an event. In one example, the generation of an alert signal may comprise generating and sending a message (an email message) to an operator to make the operator aware of a potential anomaly in the event log data.

The method 500 may be repeated periodically, so that the event logs of all of the devices in the plurality of devices can be continuously checked their authenticity. Thus, in some examples, the method 500 may further comprise repeating (506) the analyzing and determining for a second period of interest beginning when the first period of interest ends. The repeating (506) may continue for a new period of interest each time the previous period of interest ends. Each time the analyzing and determining blocks are repeated, the comparing (block 502) may be performed in respect of the predicted entries for the given device during the new period of interest.

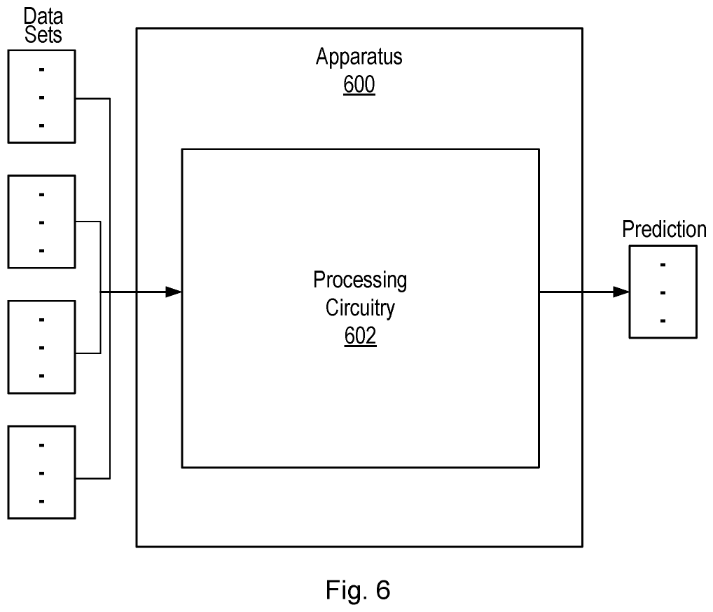

Examples disclosed herein also relate to an apparatus, such as an apparatus capable of performing the methods 300, 400, 500 disclosed herein. FIG. 6 is a schematic illustration of an example of an apparatus 600. The apparatus 600 may comprise an apparatus for determining a predicted event log entry for a device. The apparatus 600 comprises processing circuitry 602. The processing circuitry 602 may be configured or arranged to perform blocks of the methods disclosed herein. In the example shown in FIG. 6, the processing circuitry 602 is to receive, for each of a set of connected devices, a data set containing information describing events that have occurred during a first defined time period in respect of a corresponding connected device, the set of connected devices forming part of a group of connected devices that share a common attribute. The set of connected devices may comprise the plurality of devices discussed above. The data set may comprise an event log, and the defined time period may comprise the period of interest. The processing circuitry 602 is a further to establish, for a first connected device of the group of connected devices, based on the received data sets, estimated information that is expected to appear in the data set of the first connected device during the first defined time period. The first connected device may comprise the given device (i.e. the device for which a projection is to be made regarding the event log entries). Here, the information that is to be estimated may comprise an event log entry or multiple entries.

In some examples, the processing circuitry 602 may update, for the first connected device, a portion of the dataset corresponding to the first defined time period to include the estimated information stop in other words, the dataset (e.g. the event log) for the first connected device (e.g. the given device) may be updated (e.g. supplement) to include additional or replacement predicted entries (i.e. the estimated information). This may be used to fill-in or replace a portion of an event log entry for a device if the logging for that device has stopped or if the logging level for that device has been reduced, as described in the first scenario described above.

The processing circuitry 602 may, in some examples, compare the estimated information with information included in the portion of the data set corresponding to the first defined timed period for the first connected device. Responsive to determining that the estimated information differs from the information included in said portion of the data set by more than a defined amount, the processing circuitry 602 may generate an alert signal. The defined amount here may comprise a defined threshold, such that, if the estimated information differs from the information in the actual dataset by more than the defined threshold, then an alert signal is generated. This example corresponds to the second scenario described above, in which event logs for all of the devices in a plurality of devices are checked, and nominees in the event logs may be detected.

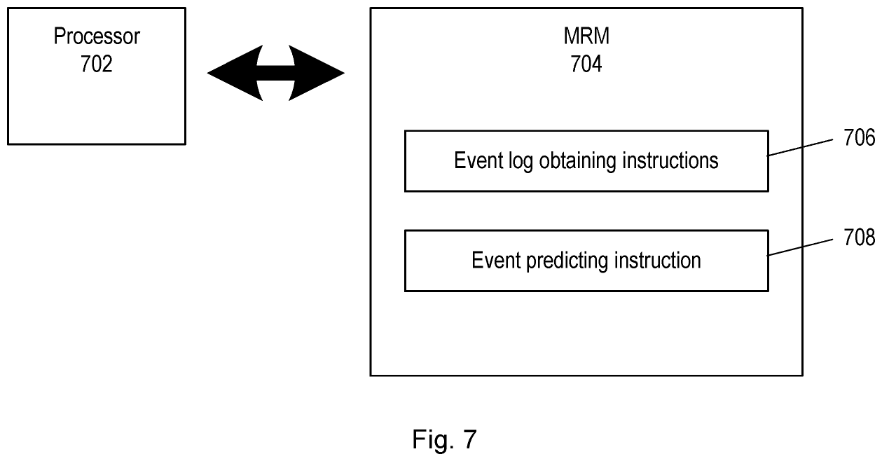

Examples disclosed herein also relate to a machine-readable medium. FIG. 7 is a schematic illustration of a machine-readable medium 704 in communication with a processor 702. The machine-readable medium 704 comprises instructions which, when executed by the processor 702, may cause the processor to perform blocks of the methods 300, 400, 500 disclosed herein. The machine-readable medium 704 comprises instructions (e.g. event log obtaining instructions 706) which, when executed by the processor 702, cause the processor to obtain a plurality of event logs, each event log detailing events that have taken place during a period of interest in relation to a corresponding device, wherein each device for which an event log is obtained belongs to a group of devices that share a common attribute. The machine-readable medium 70 for further comprises instructions (e.g. event predicting instructions 708) which, when executed by the processor 702, cause the processor to predict, based on the events detailed in the obtained event logs, an event that is expected to appear in an event log of a particular device in the group of devices. The particular device here may comprise the device referred to as a “given device” in the examples discussed above. In some examples, the machine-readable medium 704 and/or the processor 702 may comprise components of the apparatus 600 and/or maybe associated with or comprise components of the management module 104.

As noted above in various examples herein, the devices may comprise printers. In other examples, the devices may comprise any other type of device for which an event log is generated. Each of the devices may, in some examples, comprise a device selected from a group comprising: a printer, a scanner, a photocopier, and a sensing device. In some examples, the plurality of devices and/or the group of devices may include devices of different types, such as printers and scanners. In some examples, the devices may be located in an office environment. In other examples, such as where the devices comprise sensing devices, the devices may be located in an industrial environment, such as a manufacturing facility. For example, the sensing devices may comprise motion detectors or sensors associated with machinery or manufacturing equipment. Events may occur in respect of the sensing devices, and those events may be recorded in an event log in respect of each device.

Examples disclosed herein provide a mechanism by which event logs of devices are grouped according to a common attribute may be used to predict an event or events that might be expected to have occurred in respect of another device in the same group. By basing the prediction on event log entries of devices that share the same common attribute, a more accurate prediction may be made, as it may be expected that similar events may have occurred in respect of all of the devices that share the same attribute. Thus, where there exists a gap in an event log for a device, it is possible to predict the events that should have appeared within the event log, and the event log may be updated with the predicted events. Moreover, the methods disclosed herein may be used to continuously check event logs of devices within a group, and any anomalous event log entries appearing in one of the event logs may be detected, thereby enabling a security breach (e.g. an unauthorised or malicious modification of an event log) to be quickly detected.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
analyzing, using processing apparatus, event log entries of a plurality of devices, the plurality of devices forming part of a group of devices sharing a common attribute, wherein event log entries of a device relate to events that have taken place during a first period of interest in respect of that device; and
determining, using processing apparatus, for a given device in the group of devices, based on the analysis of event log entries, a predicted entry that is expected to appear in the event log of the given device during the first period of interest.

2. The method of to claim 1, further comprising, prior to said analyzing:
calculating a measure of similarity between the given device and at least one other device of the plurality of devices, based on event log entries for a defined period prior to the first period of interest;
wherein said analyzing comprises:
analyzing the event log entries for any device for which the calculated measure of similarity meets or exceeds a defined threshold similarity level.

3. The method of to claim 1, further comprising:
determining, using processing apparatus, a time within the first period of interest at which the predicted entry is expected to appear.

4. The method of to claim 3, wherein determining the time at which the predicted entry is expected to appear comprises:
discretizing the first period of interest into a plurality of intervals; and
determining the time at which the predicted entry is expected to appear based on a number of event log entries appearing in the event logs of the plurality of devices during each of the plurality of intervals.

5. The method of to claim 1, wherein event log entries for a device are recorded according to one of a plurality of levels of event logging; and
wherein the method further comprises, prior to said analyzing:
receiving an indication that a level of event logging for a device in the plurality of devices has changed;
wherein said analyzing is performed responsive to receiving the indication.

6. The method of to claim 5, further comprising:
adding, using processing apparatus, the determined predicted entry to the event log for the given device.

7. The method of to claim 1, further comprising:
comparing, using processing apparatus, the determined predicted entry with an event log entry for the given device during the first period of interest; and
responsive to determining that the predicted entry differs from the event log entry by more than a defined threshold, generating an alert signal.

8. The method of to claim 1, further comprising:
repeating the analyzing and determining for a second period of interest beginning when the first period of interest ends.

9. The method of to claim 1, further comprising:
receiving the event log entries from each of the plurality of devices.

10. The method of to claim 1, wherein the common attribute comprises an attribute selected from a group comprising: location, internet protocol address, installed software/firmware, and a network address.

11. The method of to claim 1, wherein each of the devices comprises a device selected from a group comprising: a printer, a scanner, a photocopier, and a sensing device.

12. An apparatus comprising:
processing circuitry to:
receive, for each of a set of connected devices, a data set containing information describing events that have occurred during a first defined time period in respect of a corresponding connected device, the set of connected devices forming part of a group of connected devices that share a common attribute; and
establish, for a first connected device of the group of connected devices, based on the received data sets, estimated information that is expected to appear in the data set of the first connected device during the first defined time period.

13. The apparatus of to claim 12, wherein the processing circuitry is further to:
update, for the first connected device, a portion of the data set corresponding to the first defined timed period to include the estimated information.

14. The apparatus of to claim 12, wherein the processing circuitry is further to:
compare the estimated information with information included in the portion of the data set corresponding to the first defined timed period for the first connected device; and
responsive to determining that the estimated information differs from the information included in said portion of the data set by more than a defined amount, generate an alert signal.

15. A machine-readable medium comprising instructions which, when executed by a processor, cause the processor to:
obtain a plurality of event logs, each event log detailing events that have taken place during a period of interest in relation to a corresponding device, wherein each device for which an event log is obtained belongs to a group of devices that share a common attribute; and
predict, based on the events detailed in the obtained event logs, an event that is expected to appear in an event log of a particular device in the group of devices.
